(19) United States
(12) Patent Application Publication
(10) Pub. No.: US 2007/0250645 A1
(43) Pub. Date: Oct. 25, 2007

(54) MOBILE PHONE DATA BACKUP SYSTEM

(76) Inventors: Robert Meadows, Las Vegas, NV (US); Jonathan Salcedo, San Francisco, CA (US); Garrett Larsson, Foster City, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/737,900

(22) Filed: Apr. 20, 2007

Related U.S. Application Data
(60) Provisional application No. 60/793,994, filed on Apr. 20, 2006.

(51) Int. Cl. G06F 15/16; H04M 3/00

(52) U.S. Cl. 709/248; 455/418

(57) ABSTRACT

A method and apparatus for backing-up and synchronizing mobile handset data are disclosed. According to one embodiment of the invention, a Mobile Solutions Platform (MSP) architecture and server are defined, such that the MSP provides back-up and synchronization servers to a wide variety of mobile handsets. In addition to supporting a wide variety of mobile handsets, the MSP architecture and server provide support for a wide variety of data types, to include contact information (e.g., names, addresses, and phone numbers), calendar information (e.g., meeting times, and appointment times), tasks, notes, as well as graphics and picture files, video files, and audio files (e.g., ringtones, and music files).

### RELATED APPLICATIONS

The present application is related to and claims the benefit of the filing date of U.S. Provisional Patent Application with Ser. No. 60/793,994, filed on Apr. 20, 2006, which is incorporated herein by reference.

### FIELD OF THE INVENTION

The present invention relates generally to data synchronization techniques. More specifically, the invention relates to a method and apparatus for backing up data stored on various end user devices (e.g., mobile phones) to a centralized database, and providing for the rapid synchronization of said data between the centralized database and any number and/or variety of end user devices.

### BACKGROUND

With the increasing popularity of portable, wireless devices (e.g., laptop computers, mobile phones, personal digital assistants (PDAs), handheld global positioning system (GPS) devices, digital cameras, and so on), users have an increased need to synchronize data. For instance, a user may store data—such as personal and/or business contact information—on a personal computer (PC) or on a server of a web-based data service. It is often desirable to synchronize this data with data stored on a portable device, such that a copy of the data are available on the wireless device for access by the user when on the move. Similarly, a user may want to synchronize data so that data entered on a portable device is backed-up or archived at a centrally located device. If a user loses or accidentally destroys his or her mobile device without having first backed-up the data stored on the device, the user may face the unfortunate and time consuming task of having to gather and re-enter a significant amount of important data.

A variety of problems must be overcome in providing a reliable and easy to use data back-up and synchronization service. One such problem involves developing an efficient and reliable means of moving data between devices. For instance, many prior art back-up methods require a user to physically couple a mobile device to a PC (e.g., via a serial cable connection) in order to transfer data between the devices. This method of data communication is inconvenient for a variety of reasons. The user must not only own and operate a PC, but the user must be in close proximity to the PC, and must physically attach the mobile device to the PC, in order to initiate a synchronization procedure, Furthermore, various mobile devices may utilize different serial cables configurations thereby adding to the overall complexity and cost of backing up data on different devices.

Another problem with many existing data back-up and synchronization solutions is that many existing solutions are proprietary in the sense that they do not support a wide variety of mobile devices, wireless networks, and/or data services. For instance, many back-up solutions will only work with a particular type or brand of mobile device, or with mobile devices that support a particular operating system or set of software features. Similarly, some back-up and synchronization solutions do not provide broad support for third-party and web-based contact management and calendaring services (e.g., Microsoft Outlook®, and services provided by Plaxo®, or Yahoo®, which have become increasingly popular.

With the variety of mobile devices and data services available today, many users have and use multiple mobile devices and/or multiple data services. It is terrifically inconvenient for the user to learn and use two or more back-up and/or synchronization solutions—one for each mobile device or data service. Furthermore, the technology used in mobile devices is changing and improving rapidly, and users are continually upgrading to mobile devices with more advanced feature sets. In particular, the type and variety of data stored on mobile devices continues to evolve. For instance, many mobile phones are integrated with digital still and/or video cameras, music playing applications, as well as GPS capabilities. Accordingly, mobile phones are increasingly being used to store pictures and videos, as well as geographical mapping and routing data. Many back-up and synchronization solutions are not designed and developed to easily and quickly adapt to these new data types and feature sets, and are therefore subject to rapid obsolescence.

For these reasons and others, an easy-to-use, universal, back-up and synchronization solution that supports a wide variety of devices, data types, third-party applications and data services is desirable.

### SUMMARY

A method and apparatus for backing-up and synchronizing mobile handset data are disclosed. According to one embodiment of the invention, a Mobile Solutions Platform (MSP) architecture and server are described; the MSP provides back-up and synchronization services to a wide variety of mobile handsets. In addition to supporting a wide variety of mobile handsets, the MSP architecture and server provide support for a wide variety of data types, to include, among other things, contact information (e.g., names, addresses, and phone numbers), calendar information (e.g., meeting times, and appointment times), tasks, notes, as well as graphics and picture files, video files, and audio files (e.g., ringtones, and music files). One of the key features of the MSP architecture and server is the device dependent nature in which the individual attributes for different handsets are defined. Particularly, device—specific configuration settings are defined in a server-side device table or listing (e.g., device catalog), which allows for the rapid introduction of new mobile handsets without modifying handset application code. Instead, additions or amendments to the device table can be quickly and easily made in order to provide support for newly deployed handsets. A variety of other aspects and features of the invention are described below in connection with the description of the drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 illustrates a network environment including a Mobile Solutions Provider (MSP) server 10 and a variety of end user devices 14, which may be configured to operate with the MSP server 10, according to an embodiment of the invention; and

FIG. 2 illustrates a block diagram of the various logical components making up the MSP architecture, according to one embodiment of the invention.

### DESCRIPTION

Reference will now be made in detail to an implementation consistent with the present invention as illustrated in the accompanying drawings. Wherever possible, the same reference numbers will be used throughout the drawings and the following description to refer to the same or like parts. Although discussed with reference to these illustrations, the present invention is not limited to the implementations illustrated therein. Hence, the reader should regard these illustrations merely as examples of embodiments of the present invention, the full scope of which is measured only in terms of the claims following this description.

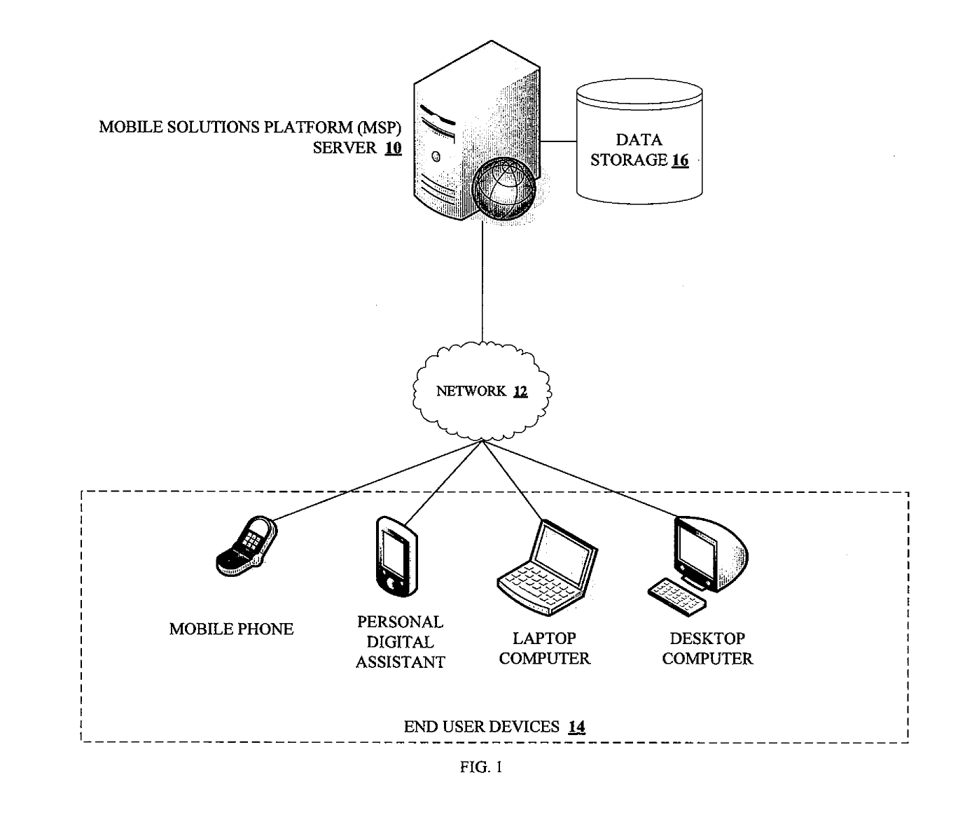

FIG. 1 illustrates a network environment including a Mobile Solutions Provider (MSP) server 10 and a variety of end user devices 14, which may be configured to operate with the MSP server 10, according to an embodiment of the invention. In contrast to conventional prior art back-up and synchronization solutions, an embodiment of the present invention provides support for a wide variety of mobile devices, data types, third-party applications and web-based data services, to include Yahoo® address and calendaring applications, Microsoft Outlook®, as well as Plaxo®. As illustrated in FIG. 1, the MSP server 10 is configured to provide data back-up and synchronization services over a network 12 to the variety of end user devices 14. The end user devices 14 may include (but not necessarily be limited to), mobile phones, personal digital assistants (PDAs), laptop computers, desktop computers, or other computing devices. As presented herein, many of the examples and much of the description relates to an embodiment of the invention that is specific to mobile phones (also referred to as mobile handsets). However, those skilled in the art will appreciate the applicability of the various aspects of the invention to other devices with varying levels of mobility, to include laptops and PCs.

The network 12 over which data is communicated typically involves one or more public and/or proprietary networks, or a combination thereof. For example, a mobile handset may communicate data over a proprietary wireless network, prior to having the data routed to the MSP server 10 over a public network, such as the Internet. Similarly, a laptop or PC may use a wired or wireless local area network to access the Internet when communicating data with the MSP server 10. In various embodiments of the invention, different underlying communication protocols may be supported to include wired and wireless protocols. For instance, one embodiment of the invention uses the transfer control protocol (TCP) and internet protocol (IP) as the primary underlying communication protocols. In one embodiment of the invention, a higher level proprietary communication protocol may be used for efficient and reliable communication between a mobile handset and the MSP server 10. For instance, a proprietary protocol referred to herein as the Intersynx protocol is used to provide a common communication mechanism by client applications executing on a wide variety of mobile handsets, according to an embodiment of the invention.

With the Intersynx communication protocol, all protocol commands are synchronous. That is, the sender always expects to receive an acknowledgement message from the receiver. If no such acknowledgement message is received by the sender, a protocol error is determined to have occurred. Accordingly, the connection is dropped and the transfer is considered incomplete. For portability and efficiency, data being transferred is compacted into a standardized compact format that is common across devices. Furthermore, according to one embodiment of the invention, communication is initiated by the client (e.g., the mobile handset) in a request-response protocol. The client initiates a request, and the MSP server 10 answers with a response. Moreover, the Intersynx protocol defines various data structures for messages being communicated between a mobile handset and the MSP server 10.

As illustrated in FIG. 1, the MSP server 10 is shown as a single component. However, those skilled in the art will appreciate that the various functions described herein and attributed to the MSP server 10 or the MSP architecture in general, may be provided by a system of distributed computing devices or servers in which various different computing devices perform specialized functions. For instance, in one embodiment of the invention, a load balancing device may distribute client-initiated requests to a group of clustered servers. In addition, the MSP architecture may include one or more database servers for storing and retrieving user data. Similarly, a web server may be utilized to provide web-based access to user data.

One advantage of the present invention is that it supports a wide variety of end user devices 14. For instance, an MSP server 10 consistent with one embodiment of the invention can send data to, and receive data from, mobile handsets operating on different carriers, from different manufacturers, and with varying software configurations and operating systems. As described in greater detail below, this is made possible in part by intelligently mapping the various data fields of data records that are supported by varying devices. For instance, a mobile device may store a particular contact in a data record where the various attributes of the contact (e.g., name, address, telephone number(s), email address(es), and so on) are stored in data fields. If two mobile devices support different numbers and types of data fields, the MSP server 10 provides intelligent mapping technology to automatically determine the proper data field of the end user device to be matched with a master data field of the MSP server 10.

In addition to supporting a wide variety of end user devices, an embodiment of the invention provides support for a wide variety of data types likely to be stored on a mobile handset. For instance, one embodiment of the invention provides support for storing contact information (e.g., names, addresses, and phone numbers), calendar information (e.g., meeting times, and appointment times), tasks, notes, as well as graphics and picture files, video files, and audio files (e.g., ringtones, and music files). In an embodiment of the invention that utilizes GPS services, geographical data such as maps, locations and routes may be supported.

Referring again to FIG. 1, in one embodiment of the invention, a handset application resides and executes on each mobile handset that is configured to operate with the MSP server 10. The handset application may be pre-installed on the handset device by the manufacturer of the handset, or alternatively, a user may use a browser application on the mobile handset to download and install the handset application. In either case, during the initial installation of the handset application, the handset application performs a dynamic device discovery routine to identify the particular handset model on which the handset application is executing. For instance, the handset application may read a model number, serial number, or some other device identifier from a non-volatile memory of the handset. For BREW, this number is called the device ID, and all devices will return a unique device ID through a particular API call requesting that device ID. For Java, a device ID is automatically created by the MSP server 10 as the Java API does not have a similar notion of returning a unique device ID. In any case, the unique device IDs are mapped to the actual name of the device through a particular file. This file allows the MSP server, and other MSP components to find the human readable version of a device name from the internal representation. Consequently, the MSP server 10 can properly configure the end user device based on a handset model associated with the identifier.

Depending on the implementation and the particular configuration, various levels and modes of synchronization operations may be performed. For instance, one embodiment of the invention provides for full synchronization operations as well as partial synchronization operations. During a full synchronization operation, all data on a mobile handset is transferred from the mobile handset to the MSP database to be stored. During a partial synchronization operation, only data that has been newly added or modified since the last synchronization operation is transferred from the mobile handset to the MSP server 10.

Consistent with one embodiment of the invention, each device on which the client application has been installed will have a default synchronization schedule. For example, a mobile handset may perform a full synchronization operation once a month with partial synchronization operations occurring on a weekly basis at a predetermined time. In addition, the user can customize the synchronization schedule to dates and times of the user's choosing. In addition, a user may manually initiate a synchronization operation. In either case, during the synchronization operation, data stored on the mobile device is communicated over a network to the MSP server 10, where it is synchronized with existing data and stored.

In general, data conflicts are handled based on a conflict resolution algorithm executed under the control of the MSP server 10. In one embodiment of the invention, a user can configure the conflict resolution settings on a per device basis, such that the user can control which device or devices should be controlling in the event of a data conflict. For instance, if a telephone number is different on a mobile handset and the MSP database 32 for the same contact, the MSP server 10 can be configured to determine which telephone number should be overwritten during a synchronization operation. In one embodiment of the invention, the data fields on the mobile handset are controlling by default, such that data on the mobile handset overwrites data in a master record of the MSP database 32 in the case of a conflict.

In one embodiment of the invention, the client application provides a user interface for the user to establish an account; access, enter, and otherwise manage data, such as contact information, scheduling information including meetings, tasks, reminders, and notes; and change configuration settings. In addition to configuring the service via a mobile handset, the MSP server 10 includes a web service interface, such that users can access their data and modify configuration settings via a conventional web browser application.

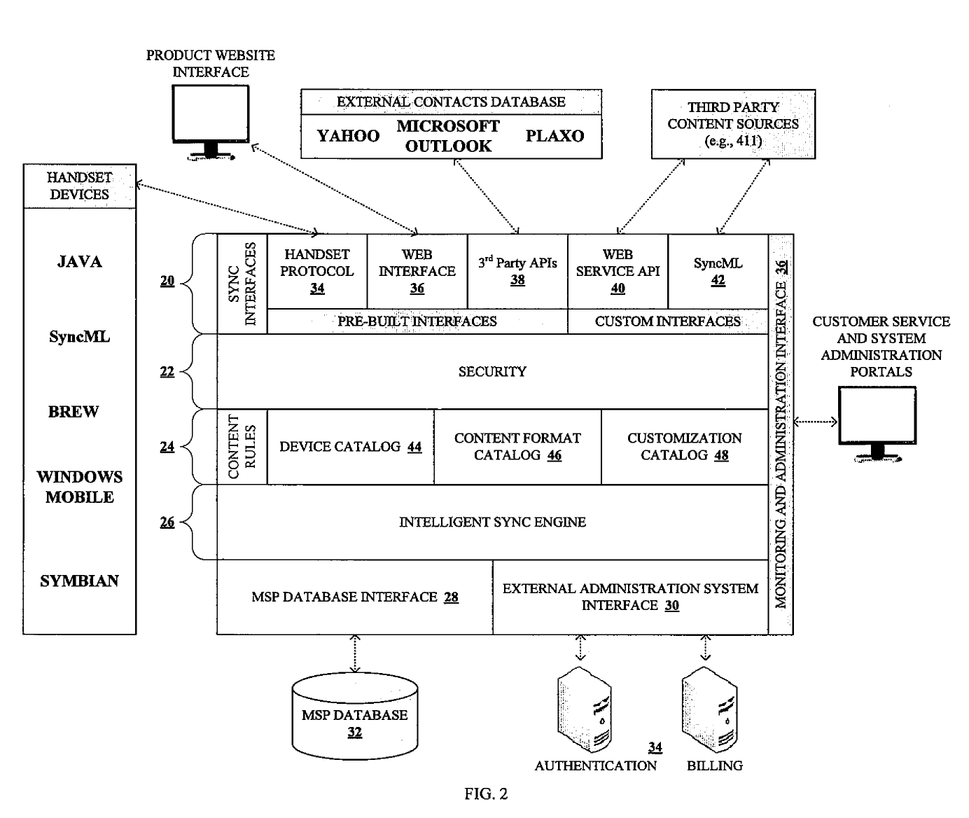

FIG. 2 illustrates a block diagram of the various logical components making up the MSP architecture, according to one embodiment of the invention. As previously described above, an MSP server 10 may be implemented in a distributed manner such that individual functions are attributable to different devices. Similarly, the individual hardware and software components that provide the functions of the various logic blocks of the MSP architecture described in connection with FIG. 2 may reside on one or more servers or computing devices. In general, the MSP provides a complete architecture for synchronization of content between mobile devices and other data sources and services. The MSP database 32 provides the central repository for user content data such as contacts, calendar, tasks, notes, ring tones, wallpaper, photos, videos, music, and other purchased and user-generated content. The MSP service manages complex synchronization tasks across multiple devices and data sources, and stores the synchronization state of each data element for each device. Synchronization endpoints can be configured by account, and can combine multiple user- and carrier-defined services. For example, one account may be configured to synchronize with a subscriber's phone, a user-defined Plaxo and Yahoo! Account, and multiple carrier services, such as 411 Directory services.

As illustrated in FIG. 2, the architecture is illustrated as having various layers. For instance, the top level layer includes the various synchronization interfaces 20. The synchronization interfaces include both pre-built interfaces, as well as custom interfaces. For instance, pre-built interfaces include those associated with existing handset communication protocols 34, websites 36, and/or third-party controlled application programming interfaces 38.

In one embodiment of the invention, various handset protocols are supported. Accordingly, a wide variety of the most popular handsets are supported, including handsets configured with J2ME, SyncML, BREW, Windows Mobile, and Symbian software. In one embodiment, a separate client application may exist for each operating system (e.g., Windows Mobile or Symbian) or software configuration supported. However, generally, a client application designed for one operating system will support a wide variety of mobile handsets that are based on that operating system. Consequently, each time a new handset is developed and deployed, an existing client application is able to support the handset with no code revision to the client application.

The MSP architecture includes a web-based interface 36, allowing users to access and manipulate their personal data stored at the MSP database 32, as well as configure various account and synchronization settings. For instance, via a web-based interface, a user may edit, add or delete a contact, a calendar item such as a meeting request, a task or a note. In addition, a user may configure various account settings, such as conflict resolution settings that determine how data conflicts between data on end user devices and the MSP database should be handled.

In addition to synchronizing data with end user devices, such as mobile handsets, an embodiment of the invention enables users to quickly and easily import data from, and synchronize data with, a wide variety of third-party data services, such as Yahoo! Address Book, Microsoft Outlook, and Plaxo. Each of these third-party resources has a unique application programming interface (API) that is supported via the third party API component 38 of the MSP synchronization interface layer 20. New data services are easily supported by the addition of new third-party APIs.

In addition to third-party APIs, the MSP architecture provides APIs to support custom server synchronization integrations. These APIs support externally initiated synchronization operations with the MSP, such as synchronization operations that might be used to integrate with customer support databases or third party websites. The MSP architecture also supports outgoing synchronizations operations, where data from the MSP database is pushed to a third-party data service. Regardless, in both outgoing and incoming synchronization operations, the MSP is used as a conflict resolution/content disambiguation point, thus keeping the MSP in the center of the user's content management system.

The SyncML component 42 provides support for SyncML—a standard for synchronizing personal organizer data between different devices. Such data includes contacts, to-do lists, and schedules. Devices might be phones, handhelds, PCs, or even services, such as web sites. SyncML provides an XML-based standard format for this data, that all SyncML-compatible devices can understand. It can work over various types of connections, including Wireless Internet, Bluetooth, and infrared. SyncML services internally use Funambol, which is an open source mobile application server software that provides push email, address book and calendar (PIM) data synchronization, application provisioning, and device management for wireless devices and PCs, leveraging standard protocols.

Under the synchronization interface layer 20 is a security layer 22, followed by a layer of content rules 24, an intelligent synchronization engine 26, and finally the MSP Database interface 28 and the external administration interface 30. In one embodiment of the invention, the security layer 22 utilizes conventional authorization and encryption methods to ensure that users and/or end user devices are properly authenticated, and all sensitive data is encrypted/decrypted when communicated over a network.

One of the key features of the MSP architecture is the externalization of content rules for managing synchronization of data across devices and other synchronization endpoints (e.g., end user devices). That is, the content rules are compartmentalized and separate from any client- or server-side executable code. For instance, content rules may simply be stored in a text file. This allows for the addition of new devices, updates of attribute rules, and the user experience without requiring code changes. The primary content rule repositories are the device catalog 44, the content format catalog 46, and the customization catalog 48.

The device catalog 44 provides the key rules for attribute formatting and other device-specific rules required to ensure proper synchronization with each supported synchronization endpoint. The purpose of the device catalog 44 is to externalize all of the content formatting information about each device into a text file that can be dynamically updated by anyone. Many times, guesses about how content should be formatted for a specific device need to be made at the time the device is initially deployed. These guesses may turn out to be wrong and may need to be “tuned” at a later time. A unique text file for each device describing these tuning parameters makes the process of formatting content correctly for a device much simpler.

The content formatting catalog 46 provides all of the specific rules for managing different content types across different synchronization endpoints. The MSP supports all popular data types including contacts, calendar, tasks, notes, ringtones, wallpaper, videos, photos, and music. Each device manufacturer may determine which data types will be exposed through their PIM or File API's, so the supported formats will generally vary by device. The MSP handles the reformatting of non-textual data (such as wallpaper) to ensure that non-supported file types are not restored to a new device.

The customization catalog 48 externalizes user- and carrier-specific application customizations. Customization options include application branding and user experience, language support, configuration of application features enabled based on carrier rules or user subscription level, etc. When a device connects to the MSP service, the incoming message includes a source IP address. Reverse DNS combined with our own IP to carrier mapping table are used to associate the incoming IP address to a particular carrier (e.g., wireless service provider). Once the carrier is identified, a list of attributes can be configured on a per carrier basis. That is, the data returned to the handset can be customized to match the preferences of the carrier. Furthermore, various menus and options may be optionally provided to the handset based on entries in the customization catalog. Consequently, services and features can be dynamically updated, added or presented to the user without installing new client code on the mobile handset.

The next layer of the MSP architecture is the intelligent sync engine 26—the heart of the MSP service. The intelligent sync engine defines the rules for managing synchronization across all supported synchronization endpoints to the central MSP data repository. The MSP maintains the current state of synchronization with each synchronization endpoint. Those external sources capable of notifying the MSP of data changes, such as Outlook via the PC-based client application, will be automatically synchronized with the central MSP Database 32 whenever changes are made. For those synchronization endpoints that do not provide change notification, the MSP will first ensure the user's data is up to date with any such external services configured for this user whenever another device or service initiates a sync with the central MSP Database 32. For example, if a user is synchronizing a phone, the MSP first verifies that the account is synchronized with services such as Yahoo or Plaxo, performs those synchronizations if necessary, and then completes the synchronization with the phone. This gives the end user experience of synchronizing directly with these third party services.

Built into the intelligent sync engine is the ability to handle external content rules. These content rules ensure proper formatting of data attributes to meet the requirements of the external applications. The MSP provides synchronization interfaces using both a Web Services API and a SyncML API to support standards-based integration for synchronization of contacts and other data content types. When a synchronization operations is initiated from a source, a synchronization occurs first with all other sources to ensure that the initiating source receives the most up-to-date information.

Referring still to FIG. 2, the MSP architecture includes a database interface 28 by which the MSP server stores and retrieves user content. The MSP Database 32 provides the central data store for all contact data, as well as ring tones, wallpaper, photos, video and other content data. In one embodiment of the invention, the database of subscribers' data is implemented in an Oracle database. Although several interface mechanisms are supported generally, in one embodiment, Hibernate is the dominant access method. The Hibernate implementation provides a data abstraction layer which allows protected access to the data in the database 32 by business logic modules. Hibernate provides support for data mapping, the breadth and depth of transactional integrity support, and ongoing industry support for this interface mechanism. The database 32 is also accessible through JDBC and J2EE, although third-party access to those interfaces is prohibited for data safety and security. Internal modules, however, utilize these interfaces to optimize performance.

The MSP architecture includes an external administration system interface 30 that provides the ability to interface with external administration and billing systems 34. This allows for integration with external authentication systems, allowing single logon integration with a carrier's website and the MSP web interface 36. Additionally, integration with outside systems enables automated subscriber provisioning when the appropriate feature code is added to that system for the subscriber.

In one embodiment of the invention, a monitoring and administration interface 36 which enables a support portal in the form of a web application that exposes common customer-service functions relating to subscribers. The support portal is meant for customers who want to deploy a turn-key solution without wanting to do any customer support integrations. It offers data search and retrieval for customer accounts. Typical support portal use includes customer account lookup and maintenance, as well as general customer use reporting. For instance, in one embodiment, through the support portal, one can create customized reports, search for users, based on search parameters, access customer profile information, and so on.

The foregoing description of various implementations of the invention has been presented for purposes of illustration and description. It is not exhaustive and does not limit the invention to the precise form or forms disclosed. Furthermore, it will be appreciated by those skilled in the art that the present invention may find practical application in a variety of alternative contexts that have not explicitly been addressed herein. Finally, the illustrative processing steps performed by a computer-implemented program (e.g., instructions) may be executed simultaneously, or in a different order than described above, and additional processing steps may be incorporated. The invention may be implemented in hardware, software, or a combination thereof. When implemented partly in software, the invention may be embodied as instructions stored on a computer- or machine-readable medium. In general, the scope of the invention is defined by the claims and their equivalents.

What is claimed is:

1. A synchronization server, comprising:
a synchronization interface component including one or more communication protocols for establishing a data communication session with a mobile handset;
content rules stored at the synchronization server and independent of any server-side executable code, wherein said content rules include a list of handset attributes supported by various handset devices; and;
an intelligent synchronization engine configured to synchronize data received from a mobile handset with data stored in a database integrated with said server.

2. The synchronization server of claim 1, wherein the content rules stored at the synchronization server include customization rules, wherein said customization rules determine services available to a user on a mobile handset.

3. The synchronization server of claim 2, wherein the content rules stored at the synchronization server define a level of customization for handsets associated with a particular carrier, and said server determines the carrier associated with a particular handset by examining a source IP address of an incoming message that is part of a connection request received at the server.

4. The synchronization server of claim 2, wherein the content rules define customizable attributes of a handset, including any one or more of the following:
branding and user experience, language support, configuration of application features enabled based on carrier rules or user subscription level.

5. The synchronization server of claim 2, wherein modifying a content rule stored at the server provides a mechanism by which new menus, representing new services, are dynamically presented on a mobile handset.

6. A method comprising:
receiving, from a mobile handset, a request to synchronize handset data with data stored at a synchronization server;
verifying said data stored at the synchronization server has recently been synchronized with data from one or more third-party data services, and if so, performing a synchronization operation to synchronize the handset data with the data stored at the synchronization server.

7. The method of claim 6, wherein, if the data stored at the synchronization server has not recently been synchronized with the data from one or more third-party data services, initiating a synchronization operation to synchronize the data stored at the synchronization server with data stored at the third-party data service.

8. The method of claim 7, wherein, after the data stored at the synchronization server has been synchronized with data stored at the third-party data service, performing a synchronization operation to synchronize the handset data with the data stored at the synchronization server.

9. The method of claim 6, wherein data conflicts arising during the synchronization operation are resolved by the synchronization server according to default data conflict rules.

10. The method of claim 6, wherein data conflicts arising during the synchronization operation are resolved by the synchronization server according to user-defined data conflict rules.
